(19) United States
(12) Patent Application Publication
(10) Pub. No.: US 2007/0203039 A1
(43) Pub. Date: Aug. 30, 2007

(54) METHOD FOR CLEANING AND MAINTAINING CONTACT LENSES AND RELATED SYSTEM AND KIT

(76) Inventors: Roya Borazjani, Ft. Worth, TX (US); Joseph C. Salamone, Boca Raton, FL (US); Michael Mulgrew, Pittsford, NY (US); Paul Erickson, Rochester, NY (US)

Correspondence Address: Bausch & Lomb Incorporated, One Bausch & Lomb Place, Rochester, NY, 14604-2701, US

(21) Appl. No.: 11/611,360

(22) Filed: Dec. 15, 2006

Related U.S. Application Data
(60) Provisional application No. 60/752,429, filed on Dec. 21, 2005.

(51) Int. Cl. C11D 3/00

(52) U.S. Cl. 510/112

(57) ABSTRACT

The present invention includes in one embodiment a method for treating contact lenses. The method comprises placing the contact lens in the eye. An eye-drop solution is administered to the contact lens while worn in the eye. The eye-drop solution has a first amount of a surfactant. The contact lens is removed from the eye. The contact lens is cleaned with a conditioning solution, cleaning solution or multipurpose solution while the lens is removed from the eye. The cleaning solution or multipurpose solution has a second amount of a surfactant that is less than the first amount.

### CROSS REFERENCE

This application claims the benefit of Provisional Patent Application No. 60/752,429 filed Dec. 21, 2005 and is incorporated herein by reference

### BACKGROUND OF THE INVENTION

1. Field of the Invention

This invention relates to the disinfection and cleaning of contact lenses and more particularly to the disinfection and cleaning of contact lenses that are worn for longer than one-day without removal.

2. Discussion of the Related Art

Contact lenses in wide use today fall into two general categories, hard and soft. The hard or rigid corneal type lenses are formed from materials prepared by the polymerization of acrylic esters, such as poly(methyl methacrylate) (PMMA). The gel, hydrogel or soft type lenses are made by polymerizing such monomers as 2-hydroxyethyl methacrylate (HEMA) or, in the case of extended wear lenses, by polymerizing silicon-containing monomers or macromonomers. Silicone-containing monomers and macromonomers are referred to as silicone hydrogel contact lenses. Silicone hydrogel contact lenses have a high oxygen permeability that allow the eye tissue to absorb oxygen at a rate that keeps tissue healthy. Thus, silicone hydrogels or other high oxygen permeable materials can be worn for extended periods of time and are often referred to as extended wear contact lenses. By extended wear contact lenses, it is meant contact lenses that are worn for longer than a day without removal from the eye.

One challenge of extended wear contact lenses is keeping the lenses free of bacteria, protein deposits, lipid deposits and debris. Extended wear contact lenses use multipurpose cleaning solutions for cleaning contact lenses. Multipurpose contact lens cleaning solutions include Optifree® Express by Alcon Laboratories, Forth Worth, Tex.; ReNu® with MoistureLoc by Bausch & Lomb, Incorporated, Rochester, N.Y.; ReNu® Multiplus by Bausch & Lomb, Incorporated, Rochester, N.Y.; Complete® Moisture Plus by Advanced Medical Optics, Santa Ana, Calif. U.S. Patent Publication No. 2005-0202986 discloses a multipurpose cleaning solution with poloxamine 407 and poloxamer 1304.

Furthermore, eye-drop solution for cleaning contact lenses are formulated to clean while the lens is placed in the eye. Eye-drops include but are not limited to Complete® Blink & Clean by Advanced Medical Optics, Santa Ana, Calif. and ReNu® MultiPlus Lubricating and Rewetting Drops, Bausch & Lomb Incorporated, Rochester, N.Y.

Presently, eye-drop solutions for treatment of contact lenses in the eye are related to multipurpose solutions, differing chiefly in that they have a reduced amount of antimicrobial agent compared to related multipurpose solutions. Never before have eye-drops been launched that are uniquely formulated to maximize the efficacy of the eye-drop compared to the multipurpose solutions with which they are designed to work.

Despite the availability of various contact lens disinfecting systems such as those discussed above, there continues to be a need for improved disinfecting systems including improved methods for disinfecting. Such improved disinfecting systems are beneficial if they are simple to use, are effective against a broad spectrum of microbes, are non-toxic and do not cause ocular irritation. There is a particular need in the field of contact lens disinfection and ophthalmic composition preservation for more safe comfortable and effective methods and compositions of treating contact lenses. There is also a need in the field of contact lens disinfection and ophthalmic composition preservation for a lens care regimen to be used when patients wear lenses for more than one day consecutively and that is more safe, comfortable, convenient and effective. The present invention addresses these and other needs.

### SUMMARY OF THE INVENTION

The present invention relates to a more balanced therapy for contact lens cleaning, disinfection and conditioning. A more effective cleaning and conditioning is possible with the methods, kits and systems set forth below.

Particularly, in one embodiment, the present invention sets forth a method for treating contact lenses. The method comprises placing the contact lens in the eye. An eye-drop solution is administered to the contact lens while worn in the eye. The eye-drop solution has a first amount of a surfactant. The contact lens is removed from the eye. The contact lens is treated with a conditioning solution, cleaning solution or multipurpose solution while the lens is removed from the eye, the cleaning solution, conditioning solution or multipurpose solution has a second amount of a surfactant that is less than the first amount.

In one embodiment, the method further comprises the step of returning the contact lens to the eye of the patient after the step of cleaning without rinsing the cleaning solution or multipurpose solution from the contact lens.

In another embodiment, the amount of the surfactant in the eye-drop solution is greater than the amount of the surfactant in the cleaning solution, conditioning solution or multipurpose solution by a factor that is a minimum of about 1.1. Typically, the first amount of the surfactant is greater than the second amount of the surfactant by a factor that is a minimum of about 1.2, about 1.5, about 2 or about 5. In one embodiment, the first amount of the surfactant is greater than the second amount by a factor that is a maximum of about 10, about 8 or about 5.

In still another embodiment, the surfactant in the eye-drop solution is selected from the group consisting of poly(ethylene oxide)-poly(propylene oxide) block copolymers and combinations thereof. In one embodiment, the surfactant in the eye-drop solution is selected from the group consisting of poloxamer surfactants, poloxamine surfactants and combinations thereof. In one preferred embodiment, the surfactant in the eye-drop solution is a combination of two or more surfactants selected from the group consisting of poloxamer 407, poloxamer 403, poloxamer 335 and poloxamine 1304.

In yet another embodiment, the amount of surfactant in the eye-drop solution is a minimum of about 3 wt. % and a maximum of about 10 wt. %. Typically, the first amount of surfactant is a minimum of about 3.5 wt. %, about 4 wt. %, about 4.5 wt. % or about 5 wt. % and/or a maximum of about 10 wt. %, about 9 wt. %, about 8 wt. %, about 7 wt. % or about 6 wt. %. In one preferred embodiment, the amount of surfactant is about 4.5 wt. %

In one embodiment, the surfactant in the cleaning solution, conditioning solution or multipurpose solution is selected from the group consisting of block copolymers of poly(ethylene oxide) and poly(propylene oxide) and combinations thereof. In one embodiment, the surfactant in the cleaning solution, conditioning solution or multipurpose solution is selected from the group consisting of poloxamine and poloxamer surfactants and combinations thereof. In one preferred embodiment, the surfactant in the cleaning solution, conditioning solution or multipurpose solution includes two or more surfactants selected from the group consisting of poloxamer 407, poloxamer 403, poloxamer 335 and poloxamine 1304.

In another embodiment, the amount of surfactant in the cleaning solution, conditioning solution or multipurpose solution is a minimum of about 1 wt. % and a maximum of about 5 wt. % so long as the amount of surfactant in the eye-drop solution is greater than the amount of the surfactant in the cleaning solution, conditioning solution or multipurpose solution. Typically, the amount of surfactant in the conditioning solution, cleaning solution or multipurpose solution is a minimum of about 1.5 wt. %, about 2 wt. %, about 2.5 wt. % or about 3 wt. % and/or a maximum of about 5 wt. %, about 4.5 wt. %, about 4 wt. %, about 3.5 wt. % or about 3 wt. %.

In still another embodiment, the eye-drop solution further comprises a preserving amount of an antimicrobial agent.

In yet another embodiment, the antimicrobial agent that is present in the eye-drop solution is selected from the group consisting of quaternary ammonium containing antimicrobial agents and combinations thereof, which include biguanide containing antimicrobial agents. Typically, the antimicrobial agent in the eye-drop solution is selected from the group consisting of biguanide containing antimicrobial agents and combinations thereof.

In one embodiment, the amount of antimicrobial agent in the eye-drop solution is a minimum of about 1 ppm and a maximum of about 100 ppm. Typically, the amount of antimicrobial agent in the eye-drop solution is a minimum of about 2 ppm, about 3 ppm, about 4 ppm or about 5 ppm. Typically, the amount of antimicrobial agent in the eye-drop solution is a maximum of about 70 ppm, about 50 ppm, about 30 ppm, about 20 ppm, about 10 ppm or about 5 ppm.

In another embodiment, the conditioning solution, cleaning solution or multipurpose solution further comprises a disinfecting amount of an antimicrobial agent. In still another embodiment, wherein the antimicrobial agent in the conditioning solution, cleaning solution or multipurpose solution is selected from the group consisting of quaternary ammonium containing antimicrobial agents and combinations thereof, including biguanide antimicrobial agents. Typically, the antimicrobial agent is selected from the group consisting of biguanide containing antimicrobial agents and combinations thereof. In one embodiment, the amount of antimicrobial agent in the conditioning solution, cleaning solution or multipurpose solution is a minimum of about 1 ppm and a maximum of about 100 ppm. Typically, the amount of antimicrobial agent in the conditioning solution, cleaning solution or multipurpose solution is a minimum of about 2 ppm, about 3 ppm, about 4 ppm or about 5 ppm. Typically, the amount of antimicrobial agent in the conditioning solution, cleaning solution or multipurpose solution is a maximum of about 70 ppm, about 50 ppm, about 30 ppm, about 20 ppm, about 10 ppm or about 5 ppm.

In yet another embodiment, the amount of antimicrobial agent in the conditioning solution, cleaning solution or multipurpose solution is greater than the amount of antimicrobial agent in the eye-drop solution by a factor that is a minimum of about 1.1. Typically the factor is a minimum of about 1.2, about 1.5, about 1.8, about 2.0, about 2.2, about 2.4, about 2.6, about 2.8 and about 3.0.

In one embodiment, the eye-drop solution further comprises a cationic polysaccharide. In another embodiment, the amount of cationic polysaccharides is a minimum of about 0.001 wt. % and a maximum of about 0.5 wt. %. The amount of cationic polysaccharide is a minimum of about 0.005 wt. %, about 0.01 wt. %, about 0.02 wt. % or about 0.04 wt. % and a maximum of about 0.05 wt. %, about 0.03 wt. % or about 0.01 wt. %.

In still another embodiment, the conditioning solution, cleaning solution or multipurpose solution further comprises a cationic polysaccharide. In another embodiment, the amount of cationic polysaccharides is a minimum of about 0.001 wt. % and a maximum of about 0.5 wt. %. The amount of cationic polysaccharide is a minimum of about 0.005 wt. %, about 0.01 wt. %, about 0.02 wt. %, about 0.04 wt. % and a maximum of about 0.05 wt. %, about 0.03 wt. % or about 0.01 wt. %.

In one embodiment, at least one surfactant in the eye-drop solution and at least one surfactant in the cleaning solution are the same.

In another embodiment, wherein at least one surfactant in the eye-drop solution and at least one surfactant in the conditioning solution, cleaning solution or multipurpose solution are different.

In one embodiment, there is a method for cleaning and conditioning contact lenses. The method comprises the steps of:

(a) administering a first solution to the eye of a person wearing a contact lens, wherein the first solution has a first amount of a surfactant;

(b) removing a contact lens from the eye of the person;

(c) administering a second solution to a contact lens when the contact lens is removed from the eye of the patient, wherein the second solution has a second amount of a surfactant that is less than the first amount of the surfactant. As disclosed herein, a first solution and a second solution representing arbitrary designations and could be an eye-drop solution, multipurpose solution, a cleaning solution or a conditioning solution. Nonetheless, in one embodiment, the first solution is preferably an eye drop solution and the second solution is a conditioning solution, a cleaning solution or a multipurpose solution.

The present invention sets forth a solution packaging for a contact lens comprising a cleaning solution, a multipurpose solution or a conditioning solution for contact lenses that includes a first amount of surfactant. Written instructions are present in the packaging of the cleaning solution, conditioning solution or multipurpose solution that teach a person to apply an eye-drop solution to the eye when the contact lenses are worn by the wearer. The eye-drop solution referred to in the instruction has a second amount of surfactant that is greater than the first amount of surfactant in the contact lens packaging solution.

In another embodiment, there is a contact lens packaging solution that comprises a first amount of surfactant. Written instruction are present with the contact lens packaging that teach a person to apply an eye-drop solution to the eye when the contact lenses are worn by the wearer. The eye drop solution referred to in the instruction has a second amount of surfactant that is greater than the first amount of surfactant in the contact lens packaging solution.

The present invention includes in one embodiment an eye-drop solution packaging for a person that wears contact lens, the package comprising:

an eye-drop solution comprising a first amount of surfactant;

written instructions that instruct the person to remove the contact lens and clean the contact lens in a conditioning solution, cleaning solution or multipurpose solution, wherein the conditioning solution, cleaning solution or multipurpose solution in the instruction has a second amount of surfactant, wherein the first amount of surfactant is greater than the second amount of surfactant.

The present invention includes, in another embodiment, a method of using a contact lens.

The method comprises applying to the eye a contact lens that has been soaked in a cleaning solution, a conditioning solution or a multipurpose solution having a first amount of surfactant. An eye-drop solution is applied to the eye wearing the contact lens, wherein the eye-drop solution has a second amount of a surfactant that is greater than the first amount of surfactant in the cleaning solution, conditioning solution or multipurpose solution.

In another embodiment, there is a combination package comprising a first vessel containing a conditioning solution, cleaning solution or multipurpose solution and a second vessel containing eye-drop solution, wherein the conditioning solution, cleaning solution or multipurpose solution has a first amount of surfactant and the eye-drop solution has a second amount of surfactant greater than the first amount of surfactant that is present in the conditioning solution, cleaning solution or multipurpose solution. Other advantages and features will be apparent from the below detailed description of the invention.

### DETAILED DESCRIPTION OF THE INVENTION

This invention is directed to aqueous compositions for cleaning lipid deposits and/or prevention of lipid deposition on medical devices, especially on contact lenses, and methods of using these compositions. The term “cleaning lipid deposits” includes preventing, removing and/or reducing the formation of lipid deposits. Combinations according to the invention have been found to improve the lipid cleaning properties for contact lenses and prevent the overgrowth of harmful bacteria and molds without adversely affecting the comfort or safety in terms of the level of toxicity to eye tissue.

Compositions of the present invention in solution are physiologically compatible or “ophthalmically safe” for use with contact lenses. Ophthalmically safe as used herein means that a contact lens treated with or in the subject solution is generally suitable and safe for direct placement on the eye without rinsing. The subject solutions are safe and comfortable for daily contact with the eye via a contact lens that has been wetted with the solution. An ophthalmically safe solution has a tonicity and pH that is compatible with the eye and comprises materials, and amounts thereof, that are non-cytotoxic according to ISO (International Standards Organization) standards and U.S. FDA (Food and Drug Administration) regulations. The solutions should be sterile in that the absence of microbial contaminants in the product prior to release should be statistically demonstrated to the degree necessary for such products. In one embodiment the cleaning solutions, the conditioning solutions, the multipurpose solutions and the eye-drops of one or more embodiments are ophthalmic solutions or ophthalmically safe solutions.

Method of Using the Multipurpose Solution and the Eye-Drop Solution

The present invention involves the use of a conditioning solution, cleaning solution or multipurpose solution by soaking the contact lens in a conditioning solution, cleaning solution or multipurpose solution for a period of time. The contact lens may be soaked prior to first use of the contact lens with a multipurpose solution or a conditioning solution to condition the contact lens. Alternatively, the contact lens solution is used after an initial use with the eye-drop solution but subsequent to an additional use. The multipurpose solution may be effectively used in cleaning lipid deposits on both hard and soft type contact lenses by any of the well-recognized methods. For example, when the wearer of contact lenses removes the lens from the eyes, the lens may be rubbed with the cleaning solution followed by soaking at room temperature for a period ranging from about four to about twelve hours. The lenses are then removed from the solution and replaced on the eyes. The wearer may optionally rinse the lenses in a preserved saline solution before replacing the lenses on the eyes.

The regimen for cleaning or disinfecting the contact lens may include a regimen of rinsing the contact lens, soaking the contact lens for a period that is a minimum of five minutes and rinsing the contact lens again. The period of soaking in any one or more regimens may be a minimum of 10 minutes, 20 minutes, 30 minutes, one hour, three hours or six hours. The maximum period for recommended soaking may be one week, twenty-four hours, twelve hours, eight hours or six hours. In one preferred embodiment, the recommended soaking time is four hours.

In addition to the cleaning regimens disclosed, the solutions disclosed herein are adaptable for use in other types of equipment such as ultrasonic cleaners. Furthermore, because the solutions are also stable when heated to temperatures in the range of 80° C. to 90° C. They are also adaptable for use with high temperature disinfecting methods. Typically, lenses are heated to 80° C. in a disinfecting unit containing the cleaning and conditioning solution for a time period of at least 10 minutes, removed and rinsed with isotonic saline.

Eye-drop solutions according to the invention may suitably be applied as follows. During wear, about one or two drops are placed directly onto each lens whenever needed. Thereafter, the wearer should blink several times. It is also possible to use a spray mist to deliver the formulation to the eye. Especially useful is the ability to clean contact lens and manage antimicrobial agents while the contact lenses are worn in the eye. Thus, as mentioned above, aqueous compositions according to the invention are especially advantageous with people who wear lenses under an extended-wear or continuous-wear regime. Extended wear is defined as a lens that is worn overnight, during sleep, preferably capable of wear for a week or more. Continuous wear is defined as a lens that is worn for at least 1 month.

The Cleaning Solutions, Conditioning Solution or Multipurpose Solution

The multipurpose solution of the present invention are characterized as having a concentration of surfactant that is less than the concentration of surfactant in the eye-drops of the present invention. A higher level of surfactant is associated with greater lipid cleaning. However, some contact lenses are sensitive to lens swelling from soaking the contact lens with high levels of lipids in the soaking solutions. Additionally, high levels of lipids may negatively affect the antimicrobial efficacy of the antimicrobial agent. Since a relatively higher disinfecting amount is required, in a multipurpose solution, particularly any ingredient or addition that requires more antimicrobial agent is disfavored. It is the soaking of the lipids for extended periods of time that increase the potential for contact lens swelling.

In another embodiment, the amount of surfactant in the conditioning solution, cleaning solution or multipurpose solution is a minimum of about 0.1 wt. % and/or a maximum of about 5 wt. %. Typically, the amount of surfactant in the conditioning solution, cleaning solution or multipurpose solution is a minimum of about 0.5 wt. %, about 1 wt. %, about 1.5 wt. %, about 2 wt. %, about 2.5 wt. % or about 3 wt. % and/or a maximum of about 5 wt. %, about 4.5 wt. %, about 4 wt. %, about 3.5 wt. % or about 3 wt. %.

Various other surfactants suitable for use in the invention are disclosed in McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Generally, useful surfactants are nonionic, water-soluble surfactants. Generally, the surfactants will have a hydrophilic-lipophilic balance (HLB) greater than about 8 and a molecular weight in the range of 400 to 30,000.

One class of preferred surfactant is block copolymers of ethylene oxide and propylene oxide, where the ratio of poly(ethylene oxide) and poly(propylene oxide) repeating units determines the hydrophilic-lipophilic balance of the surfactant. As a first example, poloxamers are poly(ethylene oxide), poly(propylene oxide) block polymers available under the tradename Pluronic® (BASF Wyandotte Corp., Wyandotte, Mich.). Specific poloxamers include poloxamer 407 (available as Pluronic® F-127) and poloxamer 108 (available as Pluronic® F-38). An additional example is meroxapol 105 (available as Pluronic® 10 R5). As a second example, poloxamines are ethylene diamine adducts of such poly(ethylene oxide), poly(propylene oxide) block polymers available under the tradename Tetronic® (BASF Wyandotte Corp.). Specific poloxamines include poloxamine 1107 (available as Tetronic® 1107) having a molecular weight from about 7,500 to about 27,000 wherein at least 40 weight percent of said adduct is poly(ethylene oxide), and poloxamine 1304 (available as Tetronic® 1304).

Particularly preferred surfactants include but are not limited to Pluronic® L10, L35, F38, L43, L44, L63, L64, P65, F68, F68LF, P75, F77, P84, P85, F87, F88, F98, P103, P104, P105, F108 and F127, as well as Tetronic® 304, 504, 704, 707, 904, 908, 909, 1104, 1107, 1304, 1307, 1504, and 1508.

Another class of surfactants is the various polyethylene glycol ethers of stearyl alcohol. A specific example is steareth-100, available under the tradename Brij® 700 (ICI Americas).

Other non-ionic surfactants include: polyethylene glycol esters of fatty acids, e.g. coconut, castor oil, polysorbate, polyoxyethylene or polyoxypropylene ethers of higher alkanes (C₁₂-C₁₈); polysorbate 20 (available under the trademark Tween® 20); polyoxyethylene (23) lauryl ether (available under the tradename Brij® 35); polyoxyethyeneglycol (40) stearate (available under the tradename Myrj® 52); polyoxyethyeneglycol (20) stearate (available under the tradename Myrj® 49); and polyoxyethylene (25) propylene glycol stearate (available under the tradename Atlas® G 2612). Another surfactant that is useful in cleaning contact lenses is tyloxapol. Another useful ingredient is a protein remover for conditioning solutions, cleaning solutions and multipurpose solutions are the hydroxyalkylphosphonates (HAP), such as those disclosed in U.S. Pat. No. 5,858,937 (Richards et al.), available under the trade name Dequest® (Monsanto Co., St. Louis, Mo.), and most preferably Dequest® 2016.

In another embodiment, the amount of the surfactant in the eye-drop solution is greater than the amount of the surfactant in the conditioning solution, cleaning solution and multipurpose solution by a factor that is a minimum of about 1.1. Typically, the amount of the surfactant is greater than the amount of the surfactant by a factor that is a minimum of about 1.2, about 1.5, about 2 or about 5. In one embodiment, the first amount of the surfactant is greater than the second amount by a factor that is a maximum of about 10, about 8 or about 5 in the eye-drop solution.

Conditioning solutions, cleaning solutions and multipurpose solutions of the present invention optionally comprise one or more cationic polysaccharides. Suitable cationic polysaccharides for use in compositions of the present invention include for example but are not limited to variations of polyquaternium-10 such as for example Polymer JR 125™ (Dow Chemical Company, Midland, Mich.) having a 2 percent solution viscosity of 75-125 cps and 1.5 to 2.2 percent nitrogen, Polymer JR 400™ (Dow Chemical Company) having a 2 percent solution viscosity of 300 to 500 cps and 1.5 to 2.2 percent nitrogen, Polymer JR 30M™ (Dow Chemical Company) having a 1 percent solution viscosity of 1,000 to 2,500 cps and 1.5 to 2.2 percent nitrogen, Polymer LR 400™ (Dow Chemical Company) having a 2 percent solution viscosity of 300 to 500 cps and 0.8 to 1.1 percent nitrogen, Polymer LR 30M™ (Dow Chemical Company) having a 1 percent solution viscosity of 1,250 to 2,250 cps and 0.8 to 1.1 percent nitrogen, and Polymer LK™ (Dow Chemical Company) having a 2 percent solution viscosity of 300 to 500 cps and 0.8 to 1.1 percent nitrogen. A preferred cationic polysaccharide for use in the present invention is Polymer JR 125™ or Polymer JR 400™.

In another embodiment, the amount of cationic polysaccharides in the conditioning solution, cleaning solution or multipurpose solution is a minimum of about 0.001 wt. % and a maximum of about 0.5 wt. %. The amount of cationic polysaccharide in the conditioning solution, cleaning solution or multipurpose solution is a minimum of about 0.005 wt. %, about 0.01 wt. %, about 0.02 wt. %, about 0.04 wt. % and/or a maximum of about 0.05 wt. %, about 0.03 wt. % or about 0.01 wt. %.

In still another embodiment, the conditioning solution, cleaning solution or multipurpose solution further comprises a disinfecting amount of an antimicrobial agent. “Disinfecting amount” means an amount needed to pass the stand-alone assay for disinfecting efficacy as accepted by the Food and Drug Administration.

In yet another embodiment, the antimicrobial agent that is present in the conditioning solution, cleaning solution or multipurpose solution is selected from the group consisting of quaternary ammonium containing antimicrobial agent and combinations thereof, including biguanide containing antimicrobial agents. Typically, the antimicrobial agent is selected from the group consisting of biguanide containing antimicrobial agents and combinations thereof. In one embodiment, the amount of antimicrobial agent in the multipurpose solution is a minimum of about 1 ppm and a maximum of about 100 ppm. Typically, the amount of antimicrobial agent in the multipurpose solution is a minimum of about 2 ppm, about 3 ppm, about 4 ppm or about 5 ppm. Typically, the amount of antimicrobial agent in the multipurpose solution is a maximum of about 70 ppm, about 50 ppm, about 30 ppm, about 20 ppm, about 10 ppm or about 5 ppm.

Suitable antimicrobial agents for use in the conditioning solution, cleaning solution or multipurpose solution include for example but are not limited to 1,1′-hexamethylenebis[5-(p-chlorophenyl)biguanide] (Chlorhexidine) or water soluble salts thereof, 1,1′-hexamethylenebis[5-(2-ethylhexyl)biguanide] (Alexidine) or water soluble salts thereof, poly(hexamethylene biguanide) (PHMB) or water soluble salts thereof, polyquaternium-1 and quaternary ammonium esters. Biguanides are described in U.S. Pat. Nos. 5,990,174; 4,758,595 and 3,428,576, each incorporated herein in its entirety by reference. The preferred antimicrobial agents are poly(aminopropyl biguanide) (PAPB), also commonly referred to as poly(hexamethylene biguanide) (PHMB), and most preferably, the antimicrobial agents is 1,1′-hexamethylenebis[5-(2-ethylhexyl)biguanide] (Alexidine).

A conditioning solution, cleaning solution or multipurpose solution of the invention, typically, has an ophthalmically compatible pH, which generally will range between about 6 to about 8, and more preferably between 6.5 to 7.8, and most preferably about 7 to 7.5. One or more conventional buffers may be employed to obtain the desired pH value. Suitable buffers include for example but are not limited to borate buffers based on boric acid and/or sodium borate, phosphate buffers based on Na₂HPO₄, NaH₂PO₄ and/or KH₂PO₄, citrate buffers based on sodium or potassium citrate and/or citric acid, sodium bicarbonate, aminoalcohol buffers, Good buffers and combinations thereof. Generally, buffers will be used in amounts ranging from about 0.05 to about 2.5 weight percent, and preferably, from about 0.1 to about 1.5 weight percent.

A conditioning solution, cleaning solution or multipurpose solution of the present invention preferably includes one or more tonicity agents to approximate the osmotic pressure of normal lachrymal fluids, which is equivalent to a 0.9 percent solution of sodium chloride or 2.5 percent glycerin solution. Such solutions are used in either isotonic or hypotonic conditions. Examples of suitable tonicity agents include but are not limited to sodium and potassium chloride, dextrose, mannose, glycerin, calcium and magnesium chloride. These agents are typically used individually in amounts that are a minimum of about 0.01 wt. % or about 0.2 wt. % and/or a maximum of about 2.5 wt. % or 1.5 wt. %.

Preferably, a tonicity agent is employed in the conditioning solution, cleaning solution or multipurpose solution in an amount to provide a final osmotic value that is a minimum of 200 mOsm/kg, 220 mOsm/kg and/or a maximum of about 450 mOsm/kg, 350 mOsm/kg or about 320 mOsm/kg.

Conditioning solution, cleaning solution or multipurpose solution, optionally, includes a wetting agent, to facilitate the composition wetting the surface of a contact lens. Within the art, the term “humectant” is also commonly used to describe these materials. A first class of wetting agents are polymer wetting agents. Examples of suitable wetting agents include for example but are not limited to poly(vinyl alcohol) (PVA), poly(N-vinylpyrrolidone) (PVP), cellulose derivatives, guar derivatives and poly(ethylene glycol). Cellulose derivatives, guar derivatives and PVA may be used to also increase viscosity of the composition, and offer this advantage if desired. Specific cellulose derivatives include for example but are not limited to hydroxypropylmethylcellulose, carboxymethylcellulose, methylcellulose, hydroxyethylcellulose, and cationic cellulose derivatives. Related to the cellulose derivatives, similar guar derivatives can be utilized, as well as non-modified guar gum. As disclosed in U.S. Pat. No. 6,274,133, cationic cellulosic polymers also help prevent accumulation of lipids and proteins on a hydrophilic lens surface. Such cationic cellulosic polymers include for example but are not limited to water soluble polymers commercially available under the CTFA (Cosmetic, Toiletry, and Fragrance Association) designation Polyquaternium-10, including the cationic cellulosic polymers available under the trade name UCARE® Polymers from Amerchol Corp., Edison, N.J., such as for example but not limited to Polymer JR™. Generally, these cationic cellulose polymers contain quaternized N,N-dimethylamino groups along the cellulosic polymer chain.

Another suitable class of wetting agents for the conditioning solutions, cleaning solutions or multipurpose solutions are non-polymeric wetting agents. Examples may include glycerin, propylene glycol, and other non-polymeric diols and glycols. The specific quantities of wetting agents used in the invention will vary depending upon the application. However, the wetting agents will typically be included in a minimum amount of about 0.01 wt. % or about 0.1 wt. % and/or a maximum of about 5 wt. % or 2 wt. %.

It will be understood that some constituents possess more than one functional attribute. For example, cellulose derivatives are suitable polymeric wetting agents, but are also referred to as “viscosity increasing agents” to increase viscosity of the composition if desired. Glycerin is a suitable non-polymeric wetting agent but is also may contribute to adjusting tonicity.

Conditioning solution, cleaning solution or multipurpose solution of the present invention may optionally include one or more sequestering agents to bind metal ions, which in the case of ophthalmic solutions, might otherwise react with protein deposits and collect on contact lenses. Suitable sequestering agents include for example but are not limited to hydroxyalkylphosphonate (HAP), ethylenediaminetetraacetic acid (EDTA) and its salts. Sequestering agents are preferably present in a minimum of about 0.01 wt. % and/or a maximum of about 0.2 wt. %.

Eye-Drop Solution

The eye-drop solutions according to the invention are for cleaning lipid deposits and/or prevention of lipid deposition on a medical device advantageously contain a higher amount of surfactant than the multipurpose solution that accompanies the surfactant. The need for higher surfactant concentration in the eye-drops is because the eye-drops become somewhat diluted by lacrimal fluid. Eye-drops have a short residence time in the eye (i.e., approximately 5 minutes) and have less time to clean contact lenses than a multipurpose solution, cleaning solution or conditioning solution that treats the contact lens when it is outside the eye. Thus, the increased amount of surfactant results in an eye-drop solution that is more effective for use in the eye.

Various other surfactants suitable for use in the invention are disclosed in McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

The straight chain polyether surfactants known as poloxamer surfactants are available from BASF Wyandotte Corp., Wyandotte, Mich., under the registered trademark “Pluronic™ (BASF).” For convenience purposes, the straight chain surfactants employed in the aqueous composition disclosed herein will be referred to as poloxamer and are generally with a numerical suffix to identify a particular grade of material.

In another embodiment, the amount of surfactant in the eye-drop solution is a minimum of about 0.5 wt. % and a maximum of about 10 wt. %. Typically the amount of surfactant in the eye-drop solution is a minimum of about 1 wt. %, 1.5 wt. %, about 2 wt. %, about 2.5 wt. % or about 3 wt. % and/or a maximum of about 10 wt. %, 5 wt. %, about 4.5 wt. %, about 4 wt. %, about 3.5 wt. % or about 3 wt. %.

Poloxamer are block copolymers consisting of propylene oxide (PO) and ethylene oxide (EO) blocks—specifically, they are poly(oxyethylene-oxypropylene-oxyethylene) triblock copolymers. Their solubility in water is generally good, but the properties of the individual block copolymers vary substantially. The nomenclature used for the block copolymers, and generally herein, is such that the first two figures, when multiplied by 100, represent the average molecular weight of the PO block, whilst the last figure, when multiplied by 10, represents the ethylene oxide content (% w/w) of the poloxamer. Thus, for Pluronic F127 (poloxamine 407), the average molecular weight of the PO block is 12000 Daltons with 70% w/w ethylene oxide content.

In one embodiment, the surfactant in the eye-drop solution is selected from the group consisting of poloxamer 407, poloxamer 403, poloxamer 335 poloxamine 1107 and poloxamine 1304.

Grades of poloxamine surfactants available with molecular weights ranging from as low as 1650 to 27,000. Properties of each grade within the series vary depending on the percent of hydrophilic units poly(oxyethylene) and molecular weight of hydrophobic units poly(oxypropylene) in the adduct. While all members within the series exhibit wetting and detergency properties, it was discovered that only certain members are suitable for use in the cleaning and conditioning solutions disclosed herein, due to the wide variation in performance characteristics regulated by their hydrophilic-hydrophobic balance. The poloxamine surfactants found suitable are those capable of demonstrating maximum cleaning efficiency in dispersing both protein and lipid deposits at ambient and elevated temperatures at lowest solution concentration without trade-offs in lens compatibility and toxicity levels, i.e. maintaining the lowest potential as an irritant to eye tissues.

The eye-drop solution of the first solution of the present invention include but are not limited to Pluronic F38™ (BASF) having a HLB of 31 and average molecular weight (AMW) of 4700;

Pluronic F68™ (BASF) having a HLB of 29 and AMW of 8400; Pluronic 68LF™ (BASF) having a HLB of 26 and AMW or 7700;

Pluronic F77™ (BASF) having a HLB of 25 and AMW of 6600; Pluronic F87™ (BASF) having a HLB of 24 and AMW of 7700;

Pluronic F88™ (BASF) having a HLB of 28 and AMW or 11400; Pluronic F98™ (BASF) having a HLB of 28 and AMW of 13000;

Pluronic P105™ (BASF) having a HLB of 15 and AMW of 6500;

Pluronic F108™ (BASF) having a HLB of 27 and AMW of 14600;

Pluronic F127™ (BASF) having a HLB of 22 and AMW of 12600;

Pluronic L35™ (BASF) having a HLB of 19 and AMW of 1900;

Pluronic L42 ™ (BASF) having a HLB of 8 and average molecular weight (AMW) of 1630;

Pluronic L63™ (BASF) having a HLB of 11 and average molecular weight (AMW) of 2650;

Pluronic L101™ (BASF) having a HLB of 1 and average molecular weight (AMW) of 3800;

Pluronic P103™ (BASF) having a HLB of 9 and average molecular weight (AMW) of 4950;

Pluronic P123™ (BASF) having a HLB of 8 and average molecular weight (AMW) of 5750;

Pluronic L122™ (BASF) having a HLB of 4 and average molecular weight (AMW) of 5000;

Pluronic L121™ (BASF) having a HLB of 1 and average molecular weight (AMW) of 4400;

Pluronic L92™ (BASF) having a HLB of 6 and average molecular weight (AMW) of 3650;

Pluronic L81™ (BASF) having a HLB of 2 and average molecular weight (AMW) of 2750;

Pluronic L72™ (BASF) having a HLB of 7 and average molecular weight (AMW) of 2750;

Pluronic L62™ (BASF) having a HLB of 7 and average molecular weight (AMW) of 2500;

Pluronic L61™ (BASF) having a HLB of 3 and average molecular weight (AMW) of 2000;

Pluronic L31™ (BASF) having a HLB of 5 and average molecular weight (AMW) of 1100;

Pluronic F38™ (BASF) having a HLB of 31 and average molecular weight (AMW) of 4700;

Pluronic F68™ (BASF) having a HLB of 29 and AMW of 8400;

Pluronic 68LF™ (BASF) having a HLB of 26 and AMW or 7700;

Pluronic F77™ (BASF) having a HLB of 25 and AMW of 6600;

Pluronic F87™ (BASF) having a HLB of 24 and AMW of 7700;

Pluronic F88™ (BASF) having a HLB of 28 and AMW or 11400;

Pluronic F98™ (BASF) having a HLB of 28 and AMW of 13000;

Pluronic F108™ (BASF) having a HLB of 27 and AMW of 14600;

Pluronic F127™ (BASF) having a HLB of 22 and AMW of 12600;

Pluronic L35™ (BASF) having a HLB of 19 and AMW of 1900;

Tetronic 707™ (BASF) having a HLB of 27 and AMW of 12200;

Tetronic 908™ (BASF) having a HLB of 31 and AMW of 25000;

Tetronic 909™ (BASF) having a HLB of 32 and AMW of 30000;

Tetronic 1107™ (BASF) having a HLB of 24 and AMW of 15000;

Tetronic 1307™ (BASF) having a HLB of 24 and AMW of 18000;

Tetronic 1508™ (BASF) having a HLB of 27 and AMW of 30000.

Another class of surfactants is the various polyethylene glycol ethers of stearyl alcohol. A specific example is steareth-100, available under the tradename Brij® 700 (ICI Americas).

Other non-ionic surfactants include: polyethylene glycol esters of fatty acids, e.g. coconut, castor oil, polysorbate, polyoxyethylene or polyoxypropylene ethers of higher alkanes (C₁₂-C₁₈); polysorbate 20 (available under the trademark Tween® 20); polyoxyethylene (23) lauryl ether (available under the tradename Brij® 35); polyoxyethyeneglycol (40) stearate (available under the tradename Myrj® 52); polyoxyethyeneglycol (20) stearate (available under the tradename Myrj® 49); and polyoxyethylene (25) propylene glycol stearate (available under the tradename Atlas® G 2612). Another surfactant that is useful in contact lens rewetting and cleaning drops is tyloxapol.

The eye-drop solution of one embodiment of the present invention optionally comprises one or more cationic polysaccharides. Suitable cationic polysaccharides for use in compositions of the present invention include for example but are not limited to variations of polyquaternium-10 such as for example Polymer JR 125™ (Dow Chemical Company, Midland, Mich.) having a 2 percent solution viscosity of 75-125 cps and 1.5 to 2.2 percent nitrogen, Polymer JR 400™ (Dow Chemical Company) having a 2 percent solution viscosity of 300 to 500 cps and 1.5 to 2.2 percent nitrogen, Polymer JR 30M™ (Dow Chemical Company) having a 1 percent solution viscosity of 1,000 to 2,500 cps and 1.5 to 2.2 percent nitrogen, Polymer LR 400™ (Dow Chemical Company) having a 2 percent solution viscosity of 300 to 500 cps and 0.8 to 1.1 percent nitrogen, Polymer LR 30M™ (Dow Chemical Company) having a 1 percent solution viscosity of 1,250 to 2,250 cps and 0.8 to 1.1 percent nitrogen, and Polymer LK™ (Dow Chemical Company) having a 2 percent solution viscosity of 300 to 500 cps and 0.8 to 1.1 percent nitrogen. The preferred cationic polysaccharide for use in the present invention is Polymer JR 125™ or Polymer JR 400™.

In another embodiment, the amount of cationic polysaccharides in the eye-drop solution is a minimum of about 0.001 wt. % and a maximum of about 0.5 wt. %. Preferably, the amount of cationic polysaccharide in the eye-drop solution is a minimum of about 0.005 wt. %, about 0.01 wt. %, about 0.02 wt. %, about 0.04 wt. % and/or a maximum of about 0.05 wt. %, about 0.03 wt. %, about 0.01 wt. % or about 0.005 wt. %.

In still another embodiment, the eye-drop solution further comprises a preserving amount of an antimicrobial agent. “Preserving amount” is meant to be an amount required to pass the stand alone preservative efficacy test required by the Food and Drug Administration.

In yet another embodiment, the antimicrobial agent that is present in the eye-drop solution is selected from the group consisting of quaternary ammonium containing antimicrobial agents and combinations thereof, including biguanide containing antimicrobial agents. Typically, the antimicrobial agent is selected from the group consisting of biguanide containing antimicrobial agents and combinations thereof. In one embodiment, the amount of antimicrobial agent in the eye-drop solution is a minimum of about 1 ppm and a maximum of about 100 ppm. Typically, the amount of antimicrobial agent in the eye-drop solution is a minimum of about 2 ppm, about 3 ppm, about 4 ppm or about 5 ppm. Typically, the amount of antimicrobial agent in the eye-drop solution is a maximum of about 70 ppm, about 50 ppm, about 30 ppm, about 20 ppm, about 10 ppm or about 5 ppm.

Suitable antimicrobial agents for use in the eye-drop solution include for example but are not limited to 1,1′-hexamethylenebis[5-(p-chlorophenyl)biguanide] (Chlorhexidine) or water soluble salts thereof, 1,1′-hexamethylenebis[5-(2-ethylhexyl)biguanide] (Alexidine) or water soluble salts thereof, poly(hexamethylene biguanide) (PHMB) or water soluble salts thereof, polyquaternium-1 and quaternary ammonium esters. Biguanides are described in U.S. Pat. Nos. 5,990,174; 4,758,595 and 3,428,576, each incorporated herein in its entirety by reference. The preferred antimicrobial agents are poly(aminopropyl biguanide) (PAPB), also commonly referred to as poly(hexamethylene biguanide) (PHMB), and most preferably, the antimicrobial agents is 1,1′-hexamethylene-bis[5-(2-ethylhexyl)biguanide] (Alexidine).

The eye-drop solutions of the present invention, preferably, have an ophthalmically compatible pH, which generally will range between about 6 to about 8, and more preferably between 6.5 to 7.8, and most preferably about 7 to 7.5. One or more conventional buffers may be employed to obtain the desired pH value. Suitable buffers include for example but are not limited to borate buffers based on boric acid and/or sodium borate, phosphate buffers based on Na₂HPO₄, NaH₂PO₄ and/or KH₂PO₄, citrate buffers based on sodium or potassium citrate and/or citric acid, sodium bicarbonate, aminoalcohol buffers, amino acid buffers, Good buffers and combinations thereof. Generally, buffers will be used in the eye-drop solution in amounts ranging from about 0.05 to about 2.5 weight percent, and preferably, from about 0.1 to about 1.5 weight percent.

The eye-drop solution of the present invention, typically, include one or more tonicity agents to approximate the osmotic pressure of normal lachrymal fluids, which is equivalent to a 0.9 percent solution of sodium chloride or 2.5 percent glycerin solution. Examples of suitable tonicity agents include but are not limited to sodium and potassium chloride, dextrose, mannose, glycerin, calcium and magnesium chloride. These agents are typically used individually in amounts that are a minimum of about 0.01 wt. % or about 0.2 wt. % and/or a maximum of about 2.5 wt. % or 1.5 wt. %.

Preferably, the tonicity agent is employed in the eye-drop solutions an amount to provide a final osmotic value that is a minimum of 200 mOsm/kg, 220 mOsm/kg and/or a maximum of about 450 mOsm/kg, 350 mOsm/kg or about 320 mOsm/kg.

Eye-drop solutions of the present invention may likewise include a wetting agent, to facilitate the composition wetting the surface of a contact lens. Within the art, the term “humectant” is also commonly used to describe these materials. A first class of wetting agents are polymer wetting agents. Examples of suitable wetting agents include for example but are not limited to poly(vinyl alcohol) (PVA), poly(N-vinylpyrrolidone) (PVP), cellulose derivatives and poly(ethylene glycol). Cellulose derivatives and PVA may be used to also increase viscosity of the composition, and offer this advantage if desired. Specific cellulose derivatives include for example but are not limited to hydroxypropylmethylcellulose, carboxymethylcellulose, methylcellulose, hydroxypropyl cellulose, hydroxyethylcellulose, alginate, carbomer, chondroitin sulfate, hyaluronic acid, guar gum, and cationic cellulose derivatives. As disclosed in U.S. Pat. No. 6,274,133, cationic cellulosic polymers also help prevent accumulation of lipids and proteins on a hydrophilic lens surface. Such cationic cellulosic polymers include for example but are not limited to water soluble polymers commercially available under the CTFA (Cosmetic, Toiletry, and Fragrance Association) designation polyquaternium-10, including the cationic cellulosic polymers available under the trade name UCARE® Polymers from Amerchol Corp., Edison, N.J., such as for example but not limited to Polymer JR™. Generally, these cationic cellulose polymers contain quaternized N,N-dimethylamino groups along the cellulosic polymer chain.

Another suitable ingredient for eye-drop solutions are non-polymeric wetting agents. Examples may include glycerin, propylene glycol, and other non-polymeric diols and glycols. The specific quantities of wetting agents used in the invention will vary depending upon the application. However, the wetting agents will typically be included in an amount that is a minimum of about 0.01 or about 0.1 and/or a maximum of about 5 weight percent or about 2 weight percent.

It will be understood that some constituents possess more than one functional attribute. For example, cellulose derivatives are suitable polymeric wetting agents, but are also referred to as “viscosity increasing agents” to increase viscosity of the composition if desired. Glycerin is a suitable non-polymeric wetting agent but is also may contribute to adjusting tonicity.

Eye-drop solutions of the present invention may, optionally, include one or more sequestering agents to bind metal ions, which in the case of ophthalmic solutions, might otherwise react with protein deposits and collect on contact lenses. Suitable sequestering agents include for example but are not limited to ethylenediaminetetraacetic acid (EDTA) and hydroxyalkylphosphonate and its salts. Sequestering agents are preferably present in a minimum of about 0.01 wt. % and/or a maximum of about 0.2 wt. %.

Contact Lenses

Ophthalmic lenses can generally be subdivided into two major classes, namely hydrogel and rigid gas permeable lenses. Non-hydrogels do not absorb appreciable amounts of water, whereas hydrogels can absorb and retain water in an equilibrium state. Hydrogels are widely used as soft contact lens materials. It is known that increasing the hydrophilicity of the contact lens surface improves the wettability of the contact lenses. This in turn is associated with improved wear comfort of contact lenses. Additionally, the surface of the lens can affect the overall susceptibility of the lens to deposition of proteins and lipids from the tear fluid during lens wear. Accumulated deposits can cause eye discomfort or even inflammation.

The aqueous compositions of the invention can be used with all types of contact lenses such as conventional hard, soft and rigid lenses as well as silicone lenses. The term “soft lens” is meant a lens having a proportion of hydrophilic repeat units such that the water content of the lens during use is at least 20% by weight. The term “soft contact lens” as used herein generally refers to those contact lenses that readily flex under small amounts of force. Typically, soft contact lenses are formulated from polymers having a certain proportion of repeat units derived from 2-hydroxyethyl methacrylate and/or other hydrophilic monomers or macromonomers, typically crosslinked with a crosslinking agent. However, newer soft lenses, especially for extended wear, are being made from high-Dk siloxane-containing materials.

Such aqueous compositions can be used to prevent the overgrowth of harmful Gram-negative and Gram-positive bacteria such as Pseudomonas aeruginosa, Serratia marcescens and Staphylococcus aureus, as well as harmful molds and yeasts such as Aspergillus niger, and Candida albicans on the lens surfaces during wear, or during the soak time, while being gentle and non-toxic against corneal epithelial cells.

Packaging of Cleaning Solutions, Conditioning Solutions, Multipurpose Solutions and Eye-Drop Solutions

The packaging materials solution can facilitate the improved practice of lens cleaning according to one or more embodiment of the present invention. In one embodiment, the multipurpose solution, according to one or more embodiments of the present invention can be sold in a kit form in combination with an eye-drop solution that has a surfactant concentration greater than the surfactant concentration of the multipurpose solution. Any eye-drop solution according to one or more embodiments of the present invention can be sold in a kit with any of the packaging solutions according to one or more embodiments of the present invention.

In another embodiment, the multipurpose solution and the eye-drop solution are sold separately. However, in one instance, the multipurpose solution contains instructions recommending the user to select an eye-drop solution according to one or more embodiments of the invention characterized in that the concentration of surfactant in the eye-drop solution is greater than the concentration of the multipurpose solution.

In one embodiment, disposable soft contact lenses are packaged in a contact lens packaging solution. The packaging solution has a first amount of surfactant. The packaging solution teaches, instructs or recommends the user to use the contact lens with an eye drop solution that has a second amount of surfactant that is greater than the first amount of surfactant.

### EXAMPLE

Ophthalmic formulations were prepared using ophthalmically acceptable ingredients in the amounts and combinations represented in the Table Below:

| | Formula 1 | Formula 2 | Formula 3 | Formula 4 |
|---|---|---|---|---|
| Ingredient | % w/w | % w/w | % w/w | % w/w |
| Boric acid | 0.85 | 0.85 | 0.85 | 0.85 |
| Sodium chloride | 0.047 | 0.033 | 0.033 | 0.1917 |
| Sodium phosphate | 0.15 | 0.15 | 0.15 | 0.15 |
| (monobasic) | | | | |
| Sodium phosphate | 0.31 | 0.31 | 0.31 | 0.31 |
| (dibasic) | | | | |
| HAP (30%) | 0.1 | 0.1 | 0.1 | 0.1 |
| Tetronic 1107 | 1.5 | — | — | 1 |
| Pluronic F-127 | 3 | 4.5 | 4.5 | 2 |
| Pluronic P123 | 0.1 | 0.1 | — | — |
| Pluronic P105 | — | — | 0.1 | — |
| Polymer JR | 0.02 | 0.02 | 0.02 | 0.02 |
| Alexidine 2HCl | 3.00 ppm | 3.00 ppm | 3.00 ppm | 4.50 ppm |
| Purified water | Q.S. to | Q.S. to | Q.S. to | Q.S. to |
| | 100% w/w | 100% w/w | 100% w/w | 100% w/w |
| pH @ 25° C. | 6.8-7.2 | 6.8-7.2 | 6.8-7.2 | 6.8-7.2 |
| Osmolality | 240-280 | 240-280 | 240-280 | 270-300 |
| | mOsm/kg | mOsm/kg | mOsm/kg | mOsm/kg |

Formulae 1, 2 and 3 had improved lipid cleaning properties compared to Formula 4. Formula 4 is recommended as a multipurpose solution that has superior cleaning, disinfecting and conditioning properties. Formula 4, without Alexidine makes an excellent contact lens packaging solution. Formulas 1-3 with higher lipid concentration has excellent properties for cleaning lipids and is well suited for eye-drops for use while contacts are worn in the eye.

What is claimed is:

1. A method for treating contact lenses comprising the steps of:
(a) placing the contact lens in the eye;
(b) administering an eye-drop solution to the contact lens while worn in the eye, wherein the eye-drop solution has a first amount of a surfactant;
(c) removing the contact lens from the eye;
(d) cleaning the contact lens with a cleaning solution while the lens is removed from the eye, the cleaning solution has a second amount of a surfactant that is less than the first amount.

2. The method of claim 1, further comprising the step of returning the contact lens to the eye of the patient after the step of (d) cleaning without removing the cleaning solution from the contact lens.

3. The method of claim 1, wherein the first amount of the surfactant is greater than the second amount of the surfactant by a factor that is a minimum of about 1.1.

4. The method of claim 1, wherein the surfactant in the eye-drop solution is selected from the group consisting of poly(ethylene oxide)-poly(propylene oxide) block copolymers and combinations thereof.

5. The method of claim 1, wherein the amount of surfactant in the eye-drop solution is a minimum of about 3 wt. % and a maximum of about 10 wt. %.

6. The method of claim 1, wherein the surfactant in the cleaning solution is selected from the group consisting of block copolymers of poly(ethylene oxide) and poly(propylene oxide) and combinations thereof.

7. The method of claim 1, wherein the second amount of surfactant is a minimum of about 1 wt. % and a maximum of about 5 wt. %.

8. The method of claim 1, wherein the eye-drop solution further comprises a preserving amount of an antimicrobial agent.

9. The method of claim 8, wherein the antimicrobial agent that is present in the eye-drop solution is selected from the group consisting of quaternary ammonium containing antimicrobial agents and combinations thereof.

10. The method of claim 1, wherein the cleaning solution further comprises a disinfecting amount of an antimicrobial agent.

11. The method of claim 8, wherein the cleaning solution further comprises a disinfecting amount of an antimicrobial agent.

12. The method of claim 11, wherein the antimicrobial agent in the cleaning solution is selected from the group consisting of quaternary ammonium containing antimicrobial agents and combinations thereof.

13. The method of claim 8, wherein the amount of antimicrobial agent in the cleaning solutions is greater than the amount of antimicrobial agent in the eye-drop solution by a factor that is a minimum of about 1.5.

14. The method of claim 1, wherein the eye-drop solution further comprises a cationic polysaccharide.

15. The method of claim 1, wherein the amount of cationic polysaccharides in the cleaning solution is a minimum of about 0.001 wt. % and a maximum of about 0.5 wt. %.

16. The method of claim 1, wherein the eye-drop solution further comprises a cationic polysaccharide.

17. The method of claim 1, wherein the amount of cationic polysaccharides in the conditioning solution is a minimum of about 0.001 wt. % and a maximum of about 0.5 wt. %.

18. The method of claim 1, wherein at least one surfactant in the eye-drop solution and at least one surfactant in the cleaning solution are the same.

19. The method of claim 1, wherein at least one surfactant in the eye-drop solution and at least one surfactant in the cleaning solution are different.

20. A method for cleaning and conditioning contact lenses comprising the steps of:
(a) administering a first solution to the eye of a person wearing a contact lens, wherein the first solution has a first amount of a surfactant;
(b) removing a contact lens from the eye of the person;
(c) administering a second solution to a contact lens when the contact lens is removed from the eye of the patient, wherein the second solution has a second amount of a surfactant that is less than the first amount of the surfactant.

21. The method of claim 20, further comprising the step of returning the contact lens to the eye of the patient after the step of (d) cleaning without removing the second solution from the contact lens.

22. The method of claim 20, wherein the first amount of the surfactant is greater than the second amount of the surfactant by a factor that is a minimum of about 1.1.

23. The method of claim 20, wherein the surfactant in the first solution is selected from the group consisting of poly(ethylene oxide)-poly(propylene oxide) block copolymers and combinations thereof.

24. The method of claim 20, wherein the amount of surfactant in the first solution is a minimum of about 3 wt. % and a maximum of about 10 wt. %.

25. The method of claim 20, wherein the surfactant in the second solution is selected from the group consisting of block copolymers of poly(ethylene oxide) and poly(propylene oxide) and combinations thereof.

26. The method of claim 20, wherein the amount of surfactant in the second solution is a minimum of about 1 wt. % and a maximum of about 5 wt. %.

27. The method of claim 20, wherein the first solution further comprises a preserving amount of an antimicrobial agent.

28. The method of claim 27, wherein the antimicrobial agent in the first solution is selected from the group consisting of quaternary ammonium containing antimicrobial agents and combinations thereof.

29. The method of claim 20, wherein the second solution further comprises a disinfecting amount of an antimicrobial agent.

30. The method of claim 27, wherein the second solution further comprises a disinfecting amount of an antimicrobial agent.

31. The method of claim 30, wherein the antimicrobial agent in the second solution is selected from the group consisting of quaternary ammonium containing antimicrobial agents and combinations thereof.

32. The method of claim 27, wherein the amount of antimicrobial agent in the second solutions is greater than the amount of antimicrobial agent in the first solution by a factor that is a minimum of about 1.5.

33. The method of claim 20, wherein the first solution further comprises a cationic polysaccharide.

34. The method of claim 20, wherein the amount of cationic polysaccharides is a minimum of about 0.001 wt. % and a maximum of about 0.5 wt. %.

35. The method of claim 20, wherein the second solution further comprises a cationic polysaccharide.

36. The method of claim 20, wherein the amount of cationic polysaccharides is a minimum of about 0.001 wt. % and a maximum of about 0.5 wt. %.

37. The method of claim 1, wherein at least one surfactant in the first solution and at least one surfactant in the second solution are the same.

38. The method of claim 1, wherein at least one surfactant in the first solution and at least one surfactant in the second solution are different.

39. A multipurpose solution packaging for a contact lens comprising:
a cleaning solution for contact lenses comprising a first amount of surfactant;
written instructions that teach a person to apply an eye-drop solution to the eye when the contact lenses are worn by the wearer, wherein the eye-drop solution in the instruction has a second amount, wherein the second amount is greater than the first amount.

40. An eye-drop solution packaging for a person that wears contact lens, the package comprising:
an eye-drop solution comprising a first amount of surfactant;
written instructions that teach the person to remove the contact lens and clean the contact lens in a multipurpose solution, wherein the multipurpose solution in the instruction has a second amount, wherein the first amount is greater than the second amount.

41. A method of using a contact lens comprising:
applying to the eye a contact lens that has been soaked in a conditioning solution having a first amount of surfactant;
applying an eye-drop solution having a second amount of a surfactant that is greater than the first amount.

42. A combination package comprising a first vessel containing a multipurpose solution and a second vessel containing eye-drop solution, wherein the multipurpose solution has a first amount of surfactant and the eye-drop solution has a second amount of surfactant greater than the first amount.
